(19) United States
(12) Patent Application Publication
(10) Pub. No.: US 2005/0217104 A1
(43) Pub. Date: Oct. 6, 2005

(54) Method for producing concentric machine components

(76) Inventor: Hsi-Tsai Chen, Taichung City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/815,345

(22) Filed: Mar. 30, 2004

(51) Int. Cl. B65D 5/00; B23P 11/00

(52) U.S. Cl. 29/558; 29/428

(57) ABSTRACT

A method for producing concentric machine components includes the steps of: forming a blank including a tubular wall which has an inner wall face confining a central first hole that has an axis, and an outer wall face surrounding the inner wall face; cutting the blank along a cutting line that is centered at the axis of the first hole to divide the blank into inner and outer rings; boring the inner and outer rings to form a plurality of cavities at intervals in confronting surfaces of the inner and outer rings, the cavities in the inner ring complementing respectively the cavities in the outer ring to form pin holes; and placing a plurality of pins respectively in the pin holes.

### BACKGROUND OF THE INVENTION

1. Field of the Invention

The invention relates to machine components, more particularly to a method for producing concentric machine components.

2. Description of the Related Art

Referring to FIG. 1, a conventional coupling device 2 for interconnecting a driving unit and a driven unit is shown to comprise two couplers 21 and a working axle 22 between the couplers 21. Each of the couplers 21 includes inner and outer pieces 211, 212, and a plurality of rollers 213 inserted between the inner and outer pieces 211, 212. Through the rollers 213, the inner and outer pieces 211, 212 are inter-engaged so as to provide relative movements and stronger transmission effects.

The current method for producing the couplers 21 usually includes producing individually the inner and outer pieces 211, 212, after which they are assembled together. However, during assembly of the coupling device 2 and a drive axle (not shown), consideration as to whether or not their axle centers are on the same axial line must be taken to ensure the stability of their rotations, the service life of the coupling device 2, and the smooth rotation of the driven unit (not shown). Since the inner and outer pieces 211, 212 are produced individually, imprecise control of processing accuracy can lead to a large concentricity tolerance. These drawbacks lead to difficult processing for the inner and outer pieces 211, 212, which in turn leads to higher production costs.

### SUMMARY OF THE INVENTION

Therefore, the object of the present invention is to provide a method for producing concentric machine components that is capable of overcoming the aforementioned drawbacks of the prior art.

According to this invention, a method for producing concentric machine components comprises the steps of: (a) forming a blank including a tubular wall which has an inner wall face confining a central first hole that has an axis, and an outer wall face surrounding the inner wall face; (b) cutting the blank along a cutting line that extends continuously between the inner and outer wall faces around the axis and that is centered at the axis of the first hole to divide the blank into an inner ring and an outer ring which are separable from each other; (c) boring the inner and outer rings while the inner and outer rings are brought together to form a plurality of cavities at intervals in confronting surfaces of the inner and outer rings, the confronting surfaces extending along the cutting line, the cavities extending axially in the confronting surfaces, the cavities in the inner ring complementing respectively the cavities in the outer ring to form pin holes; and (d) placing a plurality of pins respectively in the pin holes.

### BRIEF DESCRIPTION OF THE DRAWINGS

Other features and advantages of the present invention will become apparent in the following detailed description of the preferred embodiment with reference to the accompanying drawings, of which:

FIG. 1 is a partly exploded perspective view of a conventional coupling device;

FIG. 2 is a flow chart, illustrating the steps involved in a preferred embodiment of the process according to the present invention;

FIG. 3 is a perspective view, illustrating a cylindrical piece used in the preferred embodiment;

FIG. 4 is a perspective view, illustrating a body formed from the cylindrical piece of FIG. 3;

FIG. 5 is a perspective view, illustrating a blank formed from the body of FIG. 4;

FIG. 6 is a perspective view, illustrating the blank after undergoing boring, threading, and chamfering processes;

FIG. 6A is a sectional view taken along line 6A-6A of FIG. 6, illustrating a cutting line for cutting the blank;

FIG. 7 illustrates an inner ring cut from the blank;

FIG. 8 illustrates an outer ring cut from the blank;

FIG. 9 illustrates the inner and outer rings when assembled together to proceed with a boring process;

FIGS. 10 and 11 illustrate respectively the inner and outer rings after the boring process;

FIG. 12 illustrates a top end of a second portion of the inner ring flush with the outer ring; and

FIG. 13 illustrates the top end of the second portion of the inner ring protruding out of the outer ring.

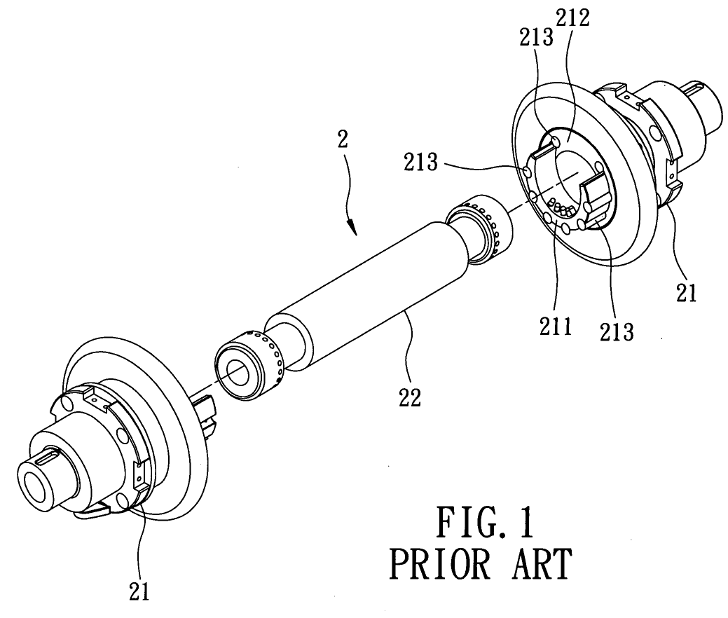

### DETAILED DESCRIPTION OF THE PREFERRED EMBODIMENT

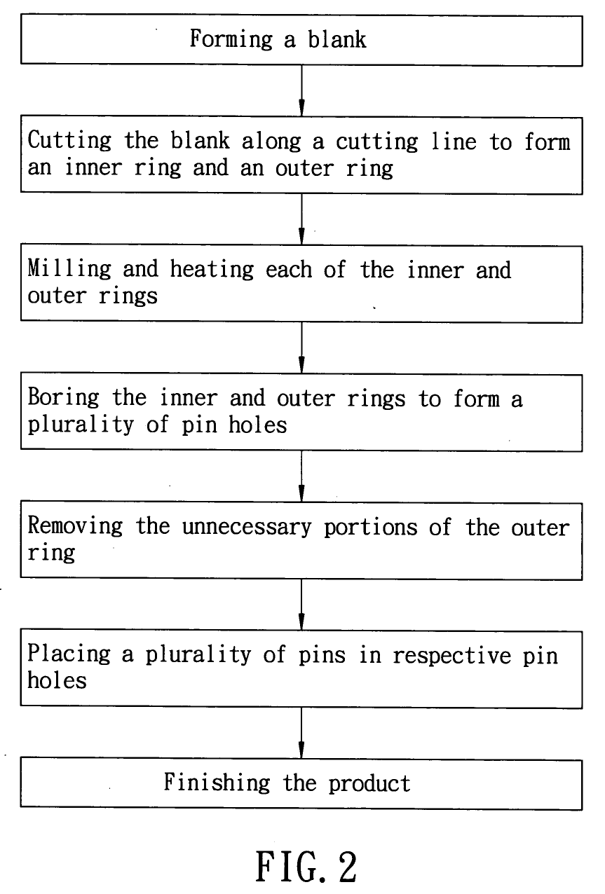

The preferred embodiment of the method for producing concentric machine components according to the present invention comprises the steps shown in FIG. 2.

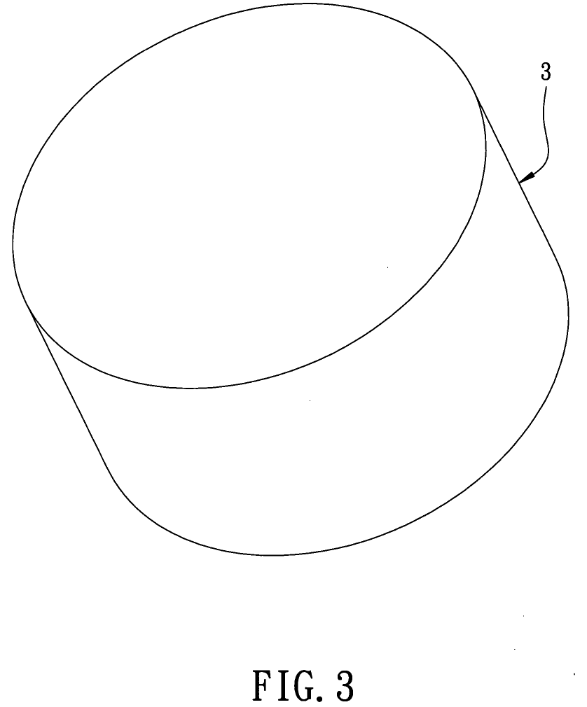

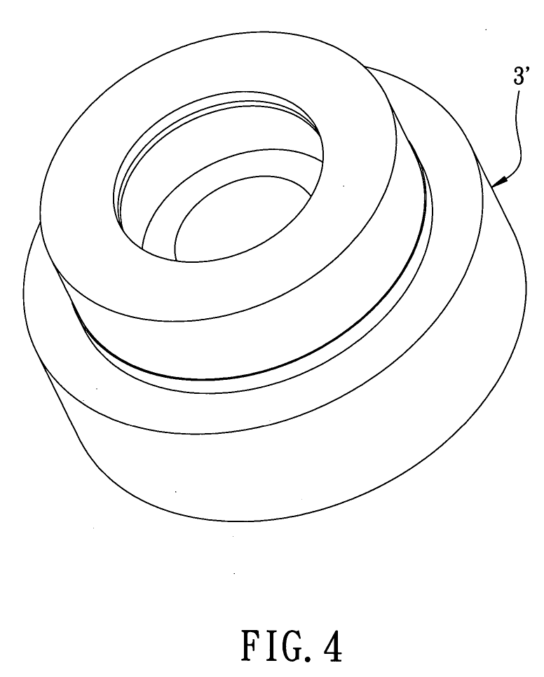

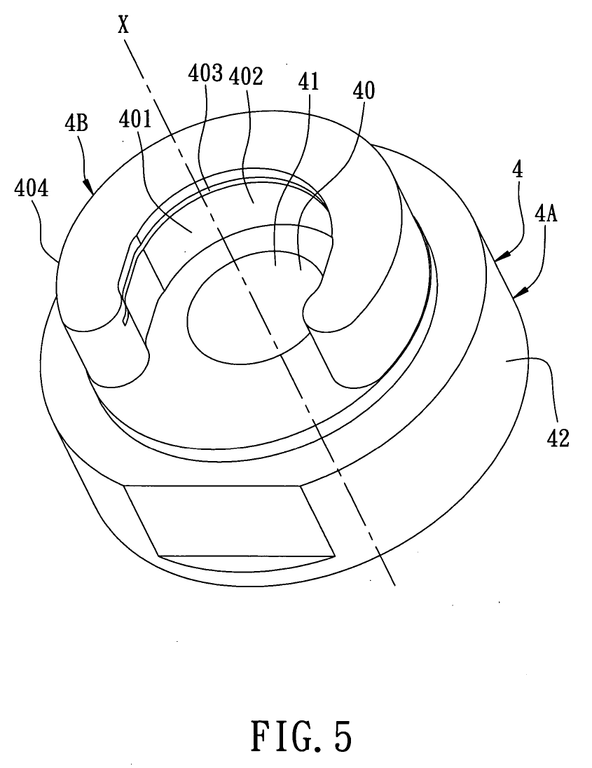

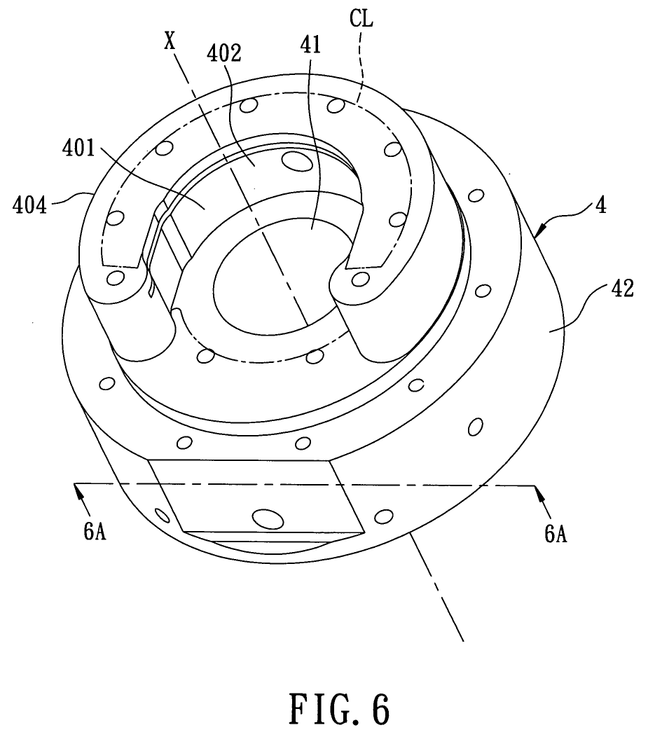

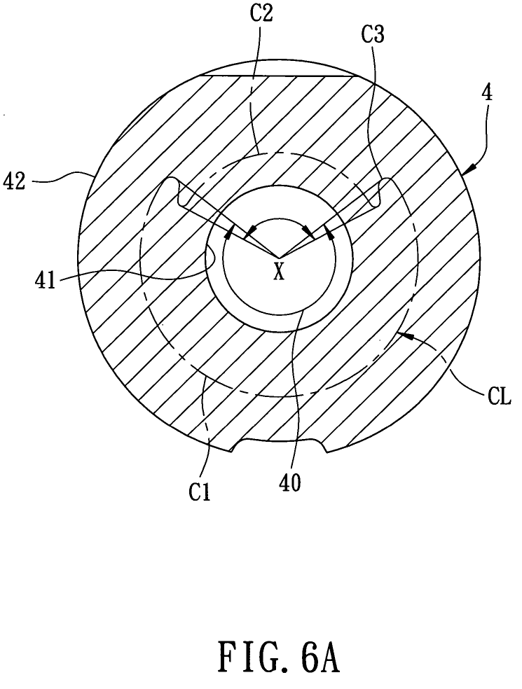

In the first step, a cylindrical piece 3 shown in FIG. 3 undergoes a machining process so as to form a body 3′ shown in FIG. 4, after which, the body 3′ is milled to form a blank 4 shown in FIG. 5. An alternative method to form the blank 4 is to directly cast or forge the cylindrical piece 3. The blank 4 has a tubular wall 4A which includes an inner wall face 41 confining a central first hole 40 that has an axis (X), and an outer wall face 42 surrounding the inner wall face 41. The blank 4 further includes a substantially C-shaped wall 4B which projects axially from the tubular wall 4A and which has an inner wall face 401 confining a second hole 402, and an outer wall face 404. The second hole 402 is coaxial with the first hole 40, and has a diameter greater than that of the first hole 40. The blank 4 then undergoes boring, threading, and chamfering processes, as shown in FIG. 6, before proceeding to the next step.

In the second step, the blank 4 is cut through a cutting process. Preferably, the blank 4 is subjected to an electrical-discharge machining process, and is cut along a cutting line (CL) shown in FIGS. 6 and 6A that extends continuously between the inner and outer wall faces 41, 42 of the tubular wall 4A and between the inner and outer wall faces 401, 404 of the C-shaped wall 4B. The cutting line (CL) extends around the first and second holes 40, 402, and is centered at the axis (X) to divide the blank 4 into an inner ring 43 and an outer ring 44 which are separable from each other. Both of the tubular wall 4A and the C-shaped wall 4B are cut in this step of the preferred embodiment. The cutting line (CL) includes a first arc section (C1) and a second arc section (C2), both of which are centered at the axis (X) of the first hole 40, and a transition section (C3) interconnecting the first and second arc sections (C1, C2). The second arc section (C2) is opposite to the first arc section (C1), and has a radius smaller than that of the first arc section (C1). The first arc section (C1) subtends a greater angle at the axis (X) than the second arc section (C2).

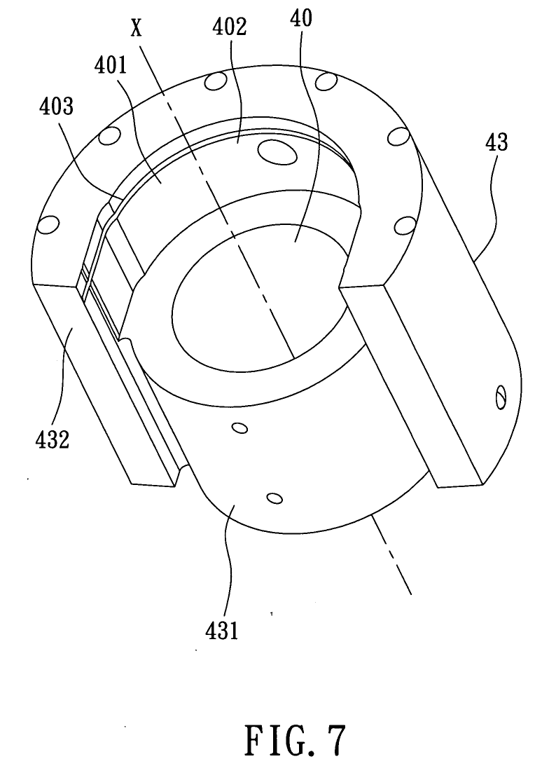

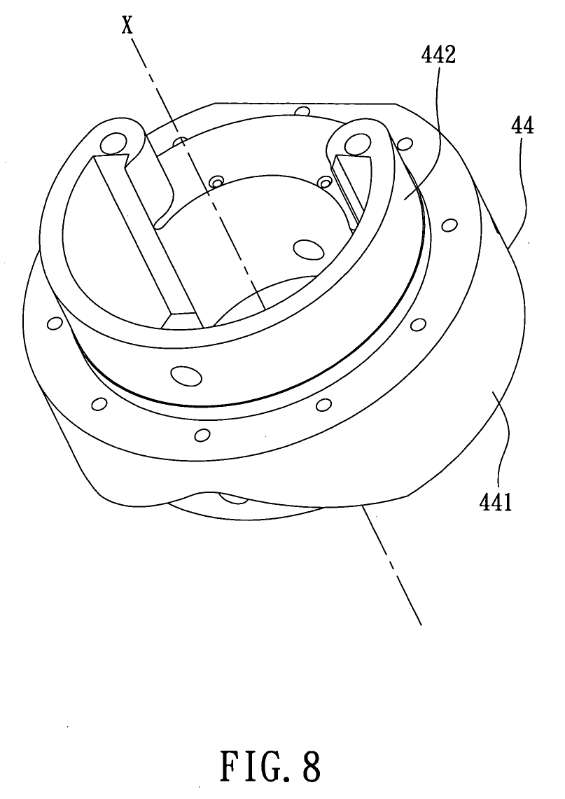

The inner ring 43 is shown in FIG. 7 to include a first portion 431 of annular shape which confines the first hole 40 and which is formed from the tubular wall 4A of the blank 4, and a second portion 432 of substantially C-shape which confines the second hole 402 and which extends around the first portion 431. The second portion 432 is formed from portions of the tubular wall 4A and the C-shaped wall 4B. A C-shaped groove 403 extends in an inner wall face of the second portion 432 around the second hole 402. The C-shaped groove 403 is preformed in the step of forming the blank 4, as shown in FIG. 5. The outer ring 44 is shown in FIG. 8 to have an annular wall 441 which is formed from the tubular wall 4A of the blank 4, and a C-shaped wall 442 connected to the annular wall 441 and corresponding to the second portion 432 of the inner ring 43. The C-shaped wall 442 is formed from the C-shaped wall 4B of the blank 4.

In the third step, each of the inner and outer rings 43, 44 undergoes milling and heating so as to finish and trim the respective surfaces of the inner and outer rings 43, 44.

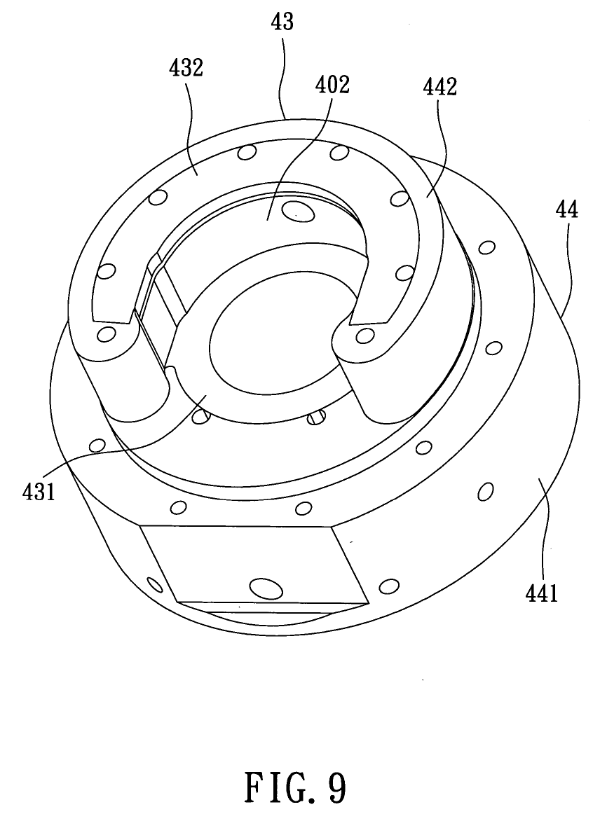

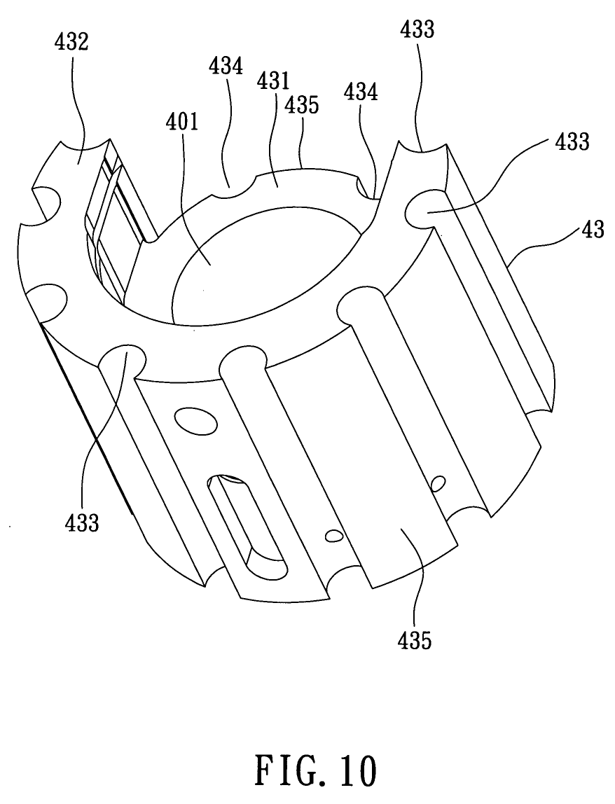

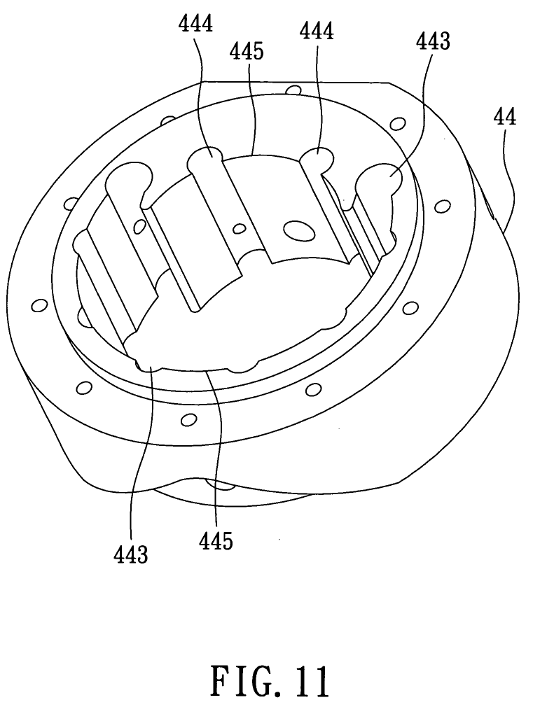

In the fourth step, the inner and outer rings 43, 44 are bored. The inner and outer rings 43, 44 are first brought together, as shown in FIG. 9, and after setting the coordinates of the inner and outer rings 43, 44, the inner and outer rings 43, 44 are subjected to an electrical-discharge machining process to bore the inner and outer rings 43, 44. A plurality of complementing first cavities 433, 443 and second cavities 434, 444 are thus formed at intervals in confronting surfaces 435, 445 of the inner and outer rings 43, 44, as shown in FIGS. 10 and 11. The confronting surfaces 435, 445 of the inner and outer rings 43, 44 extend continuously along the cutting line (CL) (see FIG. 6). The first and second cavities 433, 434, 443, 444 extend axially in the confronting surfaces 435, 445.

In the fifth step, the C-shaped wall 442 of the outer ring 44 is removed. The outer ring 44, after being cut, is annular, as shown in FIG. 11.

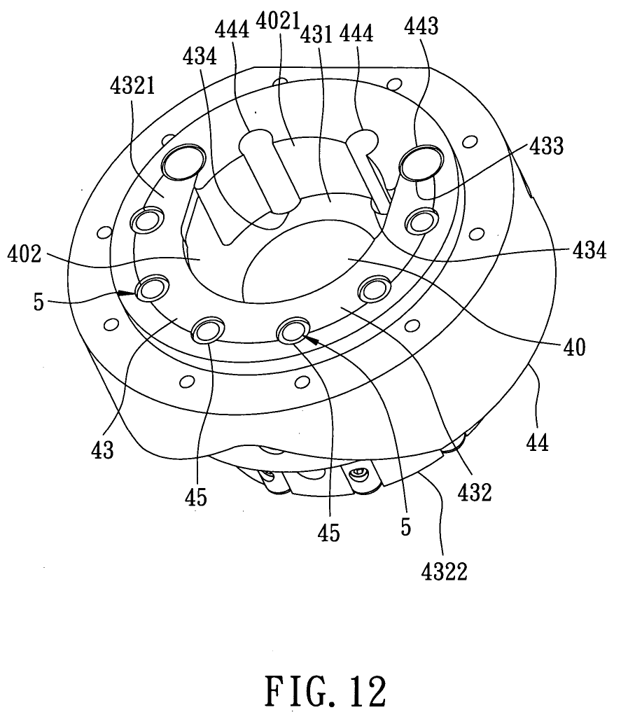

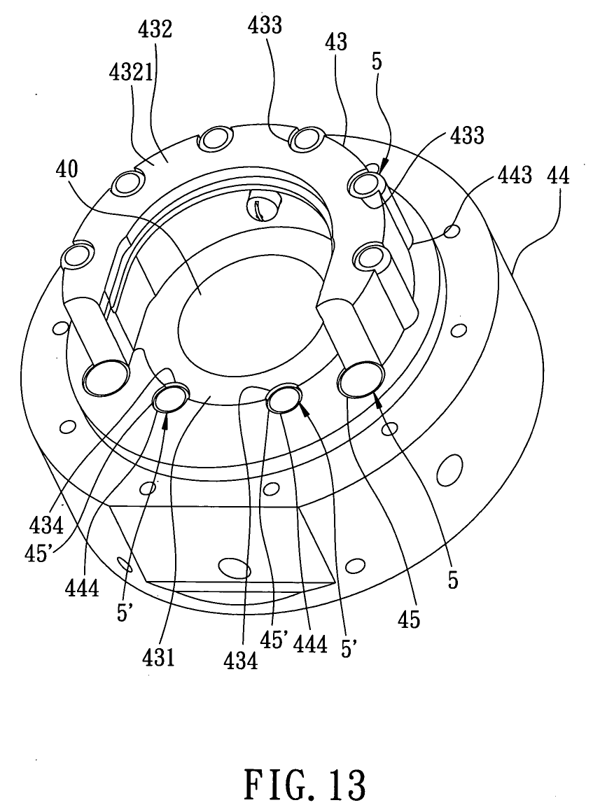

As shown in FIGS. 10 and 11, the inner ring 43 includes eight first cavities 433 which extend axially in the second portion 432 of the inner ring 43, and two second cavities 434 which extend axially in the first portion 431 of the inner ring 43. The outer ring 44 includes eight first cavities 443 and two second cavities 444 that complement respectively the first and second cavities 433, 434 in the inner ring 43 so as to form axially extending pin holes 45, 45′ (see FIGS. 12 and 13). The pin holes 45, 45′ have a circular cross section. Each of the cavities 433, 434, 443, 444 in the inner and outer rings 43, 44 has a depth from the confronting surfaces 435, 445. The depth of the cavities 433, 434 in the inner ring 43 is greater than that of the cavities 443, 444 in the outer ring 44.

In the sixth step, referring to FIG. 12, eight first pins 5 are inserted respectively into the first cavities 443 in the outer ring 44 so as to be positioned therein. Then, the second portion 432 of the inner ring 43 is inserted into the outer ring 44 by sliding along the first pins 5. Since the first cavities 433 are larger than the first cavities 443 of the outer ring 44, the inner ring 43 can be slid smoothly into the outer ring 44. When a top end 4321 of the second portion 432 of the inner ring 43 is flush with the outer ring 44, a bottom end 4322 of the second portion 432 that is opposite to the top end 4321 protrudes out of the outer ring 44. At this time, a portion 4021 of the outer ring 44 complements the second portion 432 of the inner ring 43 to define an annular wall around the second hole 402. Afterwards, a milling operation is performed to mill the portion 4021 of the outer ring 44 and the inner surface of the inner ring 43 by using the axis of the first hole 40 as a center for the milling operation so that the first and second holes 40, 402 can have good concentricity.

Finally, referring to FIG. 13, the bottom end 4322 (see FIG. 12) of the second portion 432 of the inner ring 43 is pushed upwardly so that the top end 4321 of the second portion 432 protrudes out of the outer ring 44. The second cavities 434, 444 in the inner and outer rings 43, 44 cooperate to form the pin holes 45′ at this time. Then, two second pins 5′ are inserted respectively into the pin holes 45′. With the first and second pins 5, 5′ inter-engaging the inner and outer rings 43, 44, the inner and outer rings 43, 44 can make a synchronized movement. Since the first and second pins 5, 5′ are disposed around the confronting surfaces 435, 445 (see FIGS. 10 and 11) of the inner and outer rings 43, 44, the engaging forces can be distributed uniformly between the inner and outer rings 43, 44 so that the transmission effect is enhanced.

From the aforementioned description of the preferred embodiment, the advantages of the method for producing the machine components according to the present invention can be summarized as follows:

The blank 4 is cut along the cutting line (CL) that is centered at the axis (X) of the first hole 40 to form the inner and outer rings 43, 44 so that the central axes of the inner and outer rings 43, 44 are located on the same axial line. As such, stability of the inner and outer rings 43, 44 during rotation can be ensured. Furthermore, the service lives of the inner and outer rings 43, 44 can be prolonged, and smooth transmission of the driven unit (not shown) can be ensured. Moreover, the present invention facilitates the control of the accuracy of the processing steps so that concentricity tolerance can be reduced to a minimum, and so that production costs can be minimized.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method for producing concentric machine components, comprising:
(a) forming a blank including a tubular wall which has an inner wall face confining a central first hole that has an axis, and an outer wall face surrounding said inner wall face;
(b) cutting said blank along a cutting line that continuously extends between said inner and outer wall faces around said axis and that is centered at said axis of said first hole to divide said blank into an inner ring and an outer ring which are separable from each other;
(c) boring said inner and outer rings while said inner and outer rings are brought together to form a plurality of cavities at intervals in confronting surfaces of said inner and outer rings, said confronting surfaces extending along said cutting line, said cavities extending axially in said confronting surfaces, said cavities in said inner ring complementing respectively said cavities in said outer ring to form pin holes; and
(d) placing a plurality of pins respectively in said pin holes.

2. The method as claimed in claim 1, wherein, in step (b), said blank is cut through an electrical-discharge machining process.

3. The method as claimed in claim 1, wherein, in step (c), said inner and outer rings are bored through an electrical-discharge machining process.

4. The method as claimed in claim 1, further comprising the steps of milling and heating each of said inner and outer rings after step (b).

5. The method as claimed in claim 1, wherein said pin holes have a circular cross section, each of said cavities in said inner and outer rings having a depth from said confronting surfaces, said depth of said cavities in said inner ring being greater than that of said cavities in said outer ring.

6. The method as claimed in claim 1, wherein, in step (b), said cutting line includes a first arc section and a second arc section, both of which are centered at said axis of said first hole, and a transition section interconnecting said first and second arc sections, said second arc section being opposite to said first arc section and having a radius smaller than that of said first arc section.

7. The method as claimed in claim 1, wherein, in step (a), said blank further includes a substantially C-shaped wall projecting axially from said tubular wall, said C-shaped wall confining a second hole which is coaxial with and which has a diameter greater than that of said first hole.

8. The method as claimed in claim 7, wherein both of said tubular wall and said C-shaped wall are cut in step (b) to form said inner and outer rings so that each of said inner and outer rings is composed of a portion of said tubular wall and a portion of said C-shaped wall.

9. The method as claimed in claim 8, wherein said inner ring includes a first portion of annular shape which extends around said first hole, and a second portion of substantially C-shape, said second portion extending around said first portion and further extending around said second hole, said second portion of substantially C-shape having an inner wall face formed with a C-shaped groove which extends around said second hole.

10. The method as claimed in claim 9, wherein said C-shaped groove is preformed during the step (a) of forming said blank.

11. The method as claimed in claim 8, further including the step of removing said portion of said C-shaped wall from said outer ring.

12. The method as claimed in claim 9, wherein said cavities in said inner ring include first cavities which extend axially in said second portion of said inner ring, and second cavities which extend axially in said first portion of said inner ring.
